(19) United States
(12) Patent Application Publication
(10) Pub. No.: US 2022/0245577 A1
(43) Pub. Date: Aug. 4, 2022

(54) Systems and Computerized Methods for Package Tracking Efficiency Improvements

(71) Applicant: Coupang Corp., Seoul (KR)

(72) Inventors: ERIK REHN, SEOUL (KR); MUHAMMED RIDZWAN BIN AMINUDDIN, SEOUL (KR); YOUNG SHIN KANG, INCHEON (KR)

(21) Appl. No.: 17/167,296

(22) Filed: Feb. 4, 2021

(51) Int. Cl. G06Q 10/08; G06F 16/9535

(52) U.S. Cl. CPC G06Q 10/0833; G06Q 10/06398; G06F 16/9535; G06Q 10/0838

(57) ABSTRACT

The present disclosure provides a computerized method for package management, including: receiving an item identifier corresponding to an item in response to the item being shipped; receiving a container identifier corresponding to a container comprising the item; converting the item identifier and container identifier into a standardized entry; storing the standardized entry in a data structure, the data structure correlating the item identifier with the container identifier; generating a message comprising at least one of the container identifier or a location in response to a query comprising the item identifier; and transmitting the message to a user responsible for the query.

### TECHNICAL FIELD

The present disclosure generally relates to computerized systems and methods for package tracking efficiency improvements. In particular, embodiments of the present disclosure relate to inventive and unconventional systems and methods utilized for providing tracking information updates for a grouping of items, and applying the updates to subordinate groupings and individual items.

### BACKGROUND

Modern shipping methods provide customers with tracking updates that allow customers to view a shipment status of items in transit. This increases customer satisfaction by permitting the customers to have greater visibility of their packages in transit and providing increased predictability of when a package may arrive.

However, providing high-fidelity tracking updates for large volumes of packages often requires shipping companies to manually collect large amounts of data. For example, shipping companies may need to individually scan each item arriving and departing a midpoint, such as a transfer hub, to ensure that tracking information is available to customers, as well as providing location logs to help locate missing items. In addition to requiring burdensome data collection methods, individual scanning adds delays and increases the number of personnel required to load, unload, and transfer items while in transit.

Additionally, some shippers combine packages into larger collections of items for quicker loading and unloading, for instance, by forklifts in a warehouse. Further, shippers may have “nested” groupings of items. For example, a shipper may combine items into a package, packages into a pallet, pallets into a truck, and trucks into a warehouse.

Although nested grouping of packages allows quicker transit and loading, this method inhibits tracking of individual items at the fidelity expected by modern consumers. Collecting status updates for many items held within nested groupings is often cumbersome, time-consuming, and error-prone, because warehouse operators and delivery personnel may have to account for each item hidden in multiple layers of nested groupings, thus adding extra unloading and loading steps to verify the presence of each item within larger groupings. For instance, when a truck carrying pallets containing packages with items arrives at a location, employees may need to confirm the pallets, packages, and items on the truck, and update the location for each entity of each nested grouping layer. If these updates are not performed, tracking fidelity may be degraded, and, if an item is lost, personnel may be unable to determine where the item may be found.

To illustrate further, in some traditional methods, an item may be recorded upon entering a shipping stream at an origin, and upon exiting the shipping stream at a destination. However, if the item goes missing after entering the shipping stream, the shipper may be unable to determine where the item went missing without high-fidelity tracking information of each item throughout the shipping process. Locating a missing item may be even more difficult if the item was combined with other items or transferred between warehouses and trucks. Further, the shipper may be unable to determine a responsible party, such as a worker who misplaced or stole the item, and similarly be unable to identify and stop loss trends.

Accordingly, there is a need for improved methods and systems that allow low-cost, efficient shipping by nested grouping of items while also providing high-fidelity tracking of individual items.

### SUMMARY

One aspect of the present disclosure is directed to a computerized system for package management, comprising at least one processor; and at least one non transitory storage medium storing instructions that, when executed by the at least one processor, cause the at least one processor to perform steps. The steps comprise receiving an item identifier corresponding to an item in response to the item being shipped; receiving a container identifier corresponding to a container comprising the item; converting the item identifier and container identifier into a standardized entry; storing the standardized entry in a data structure, the data structure correlating the item identifier with the container identifier; generating a message comprising at least one of the container identifier or a location in response to a query comprising the item identifier; and transmitting the message to a user responsible for the query.

Another aspect of the present disclosure is directed to a computer-implemented method for package management, comprising: receiving an item identifier corresponding to an item in response to the item being shipped; receiving a container identifier corresponding to a container comprising the item; converting the item identifier and container identifier into a standardized entry; storing the standardized entry in a data structure, the data structure correlating the item identifier with the container identifier; generating a message comprising at least one of the container identifier or a location in response to a query comprising the item identifier; and transmitting the message to a user responsible for the query.

Yet another aspect of the present disclosure is directed to a computer-implemented method for package management, comprising: receiving an item identifier corresponding to an item in response to the item being shipped; receiving a container identifier corresponding to a container comprising the item; converting the item identifier and container identifier into a standardized entry; storing the standardized entry in a data structure, the data structure correlating the item identifier with the container identifier; receiving a vehicle identifier corresponding to a vehicle transporting the container in response to the container being loaded onto the vehicle; updating the standardized entry in the data structure to correlate an identifier of the vehicle with the container; receiving an indication of a location of the vehicle; updating the standardized entry in the data structure to include the location; generating a message comprising at least one of the vehicle identifier, the container identifier, or the location in response to a query comprising the item identifier; and transmitting the message to a user responsible for the query.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of item tracking layers, consistent with the disclosed embodiments.

FIG. 4 is a flow chart illustrating an exemplary embodiment of a package management process, consistent with the disclosed embodiments.

FIG. 5 is a flow chart illustrating an exemplary embodiment of an employee fault detection process, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for efficient grouping of ordered items into packages.

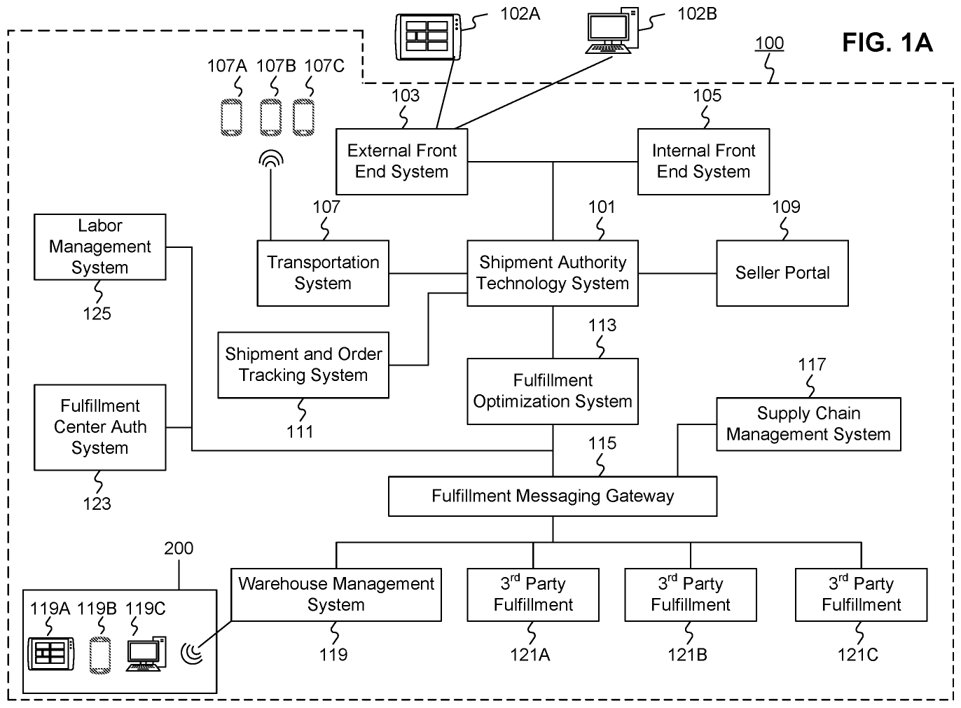

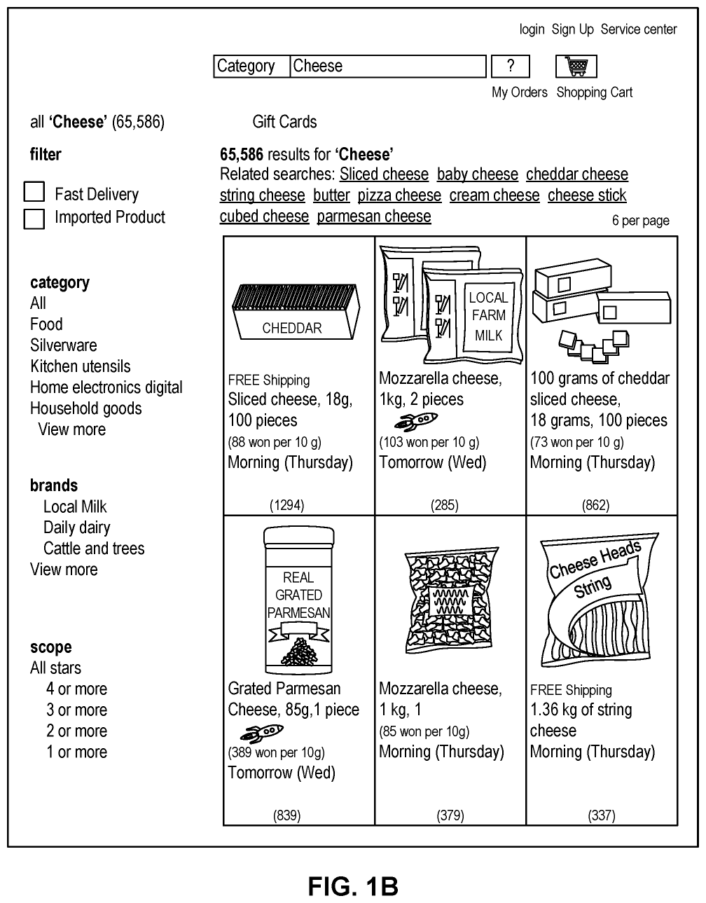

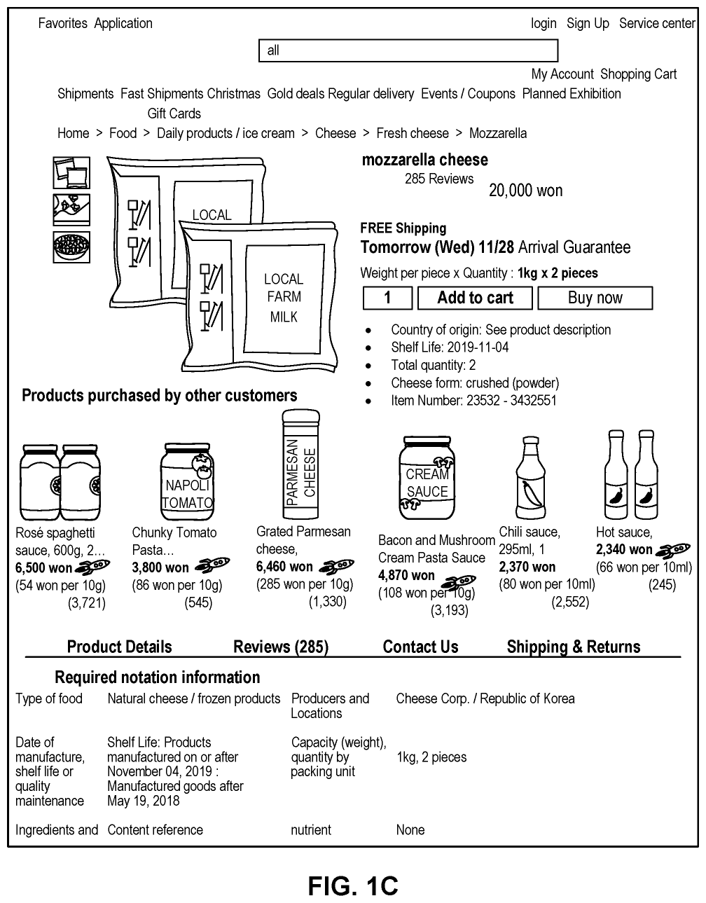

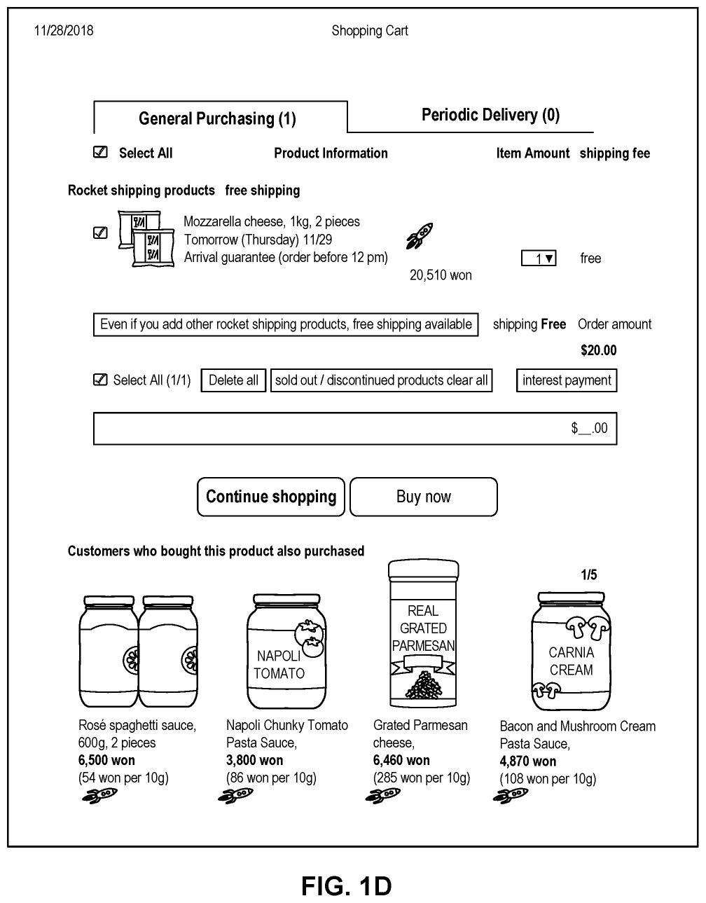

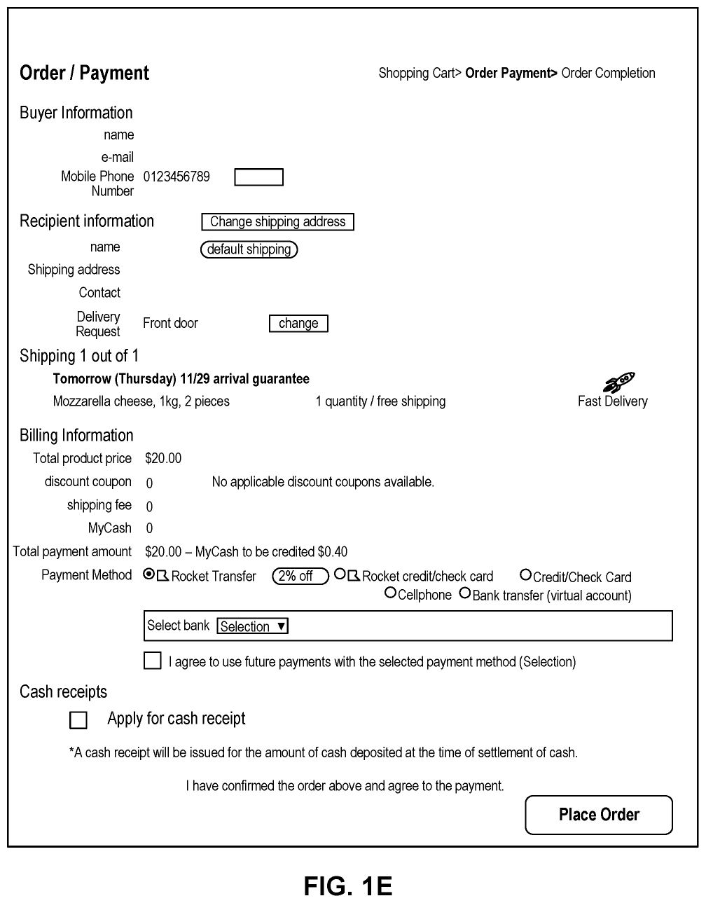

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field , a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfillment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfillment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

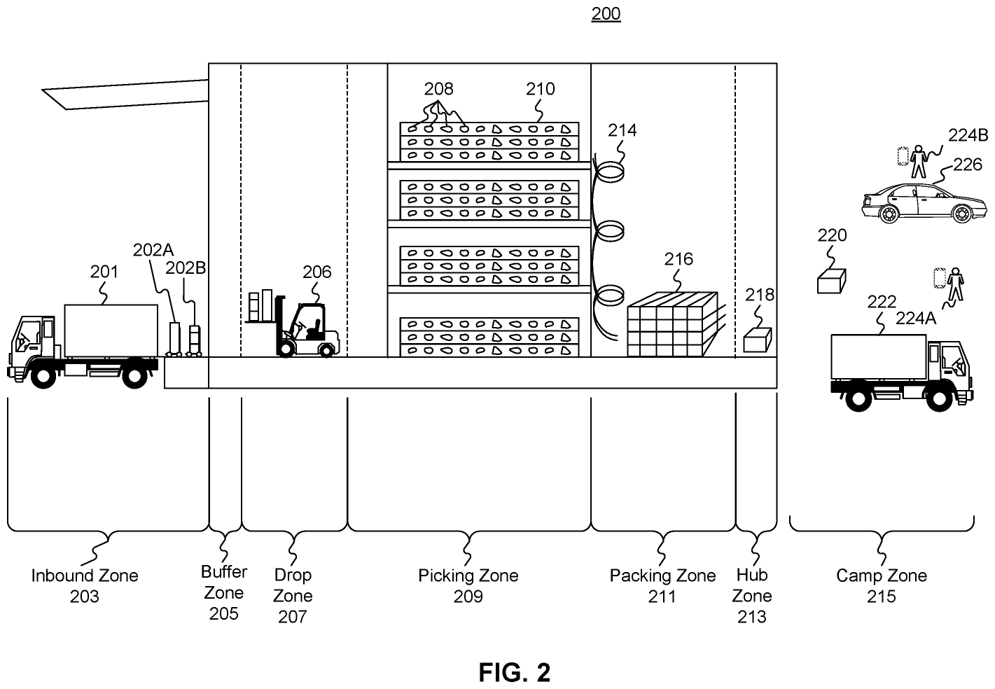

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 2246.

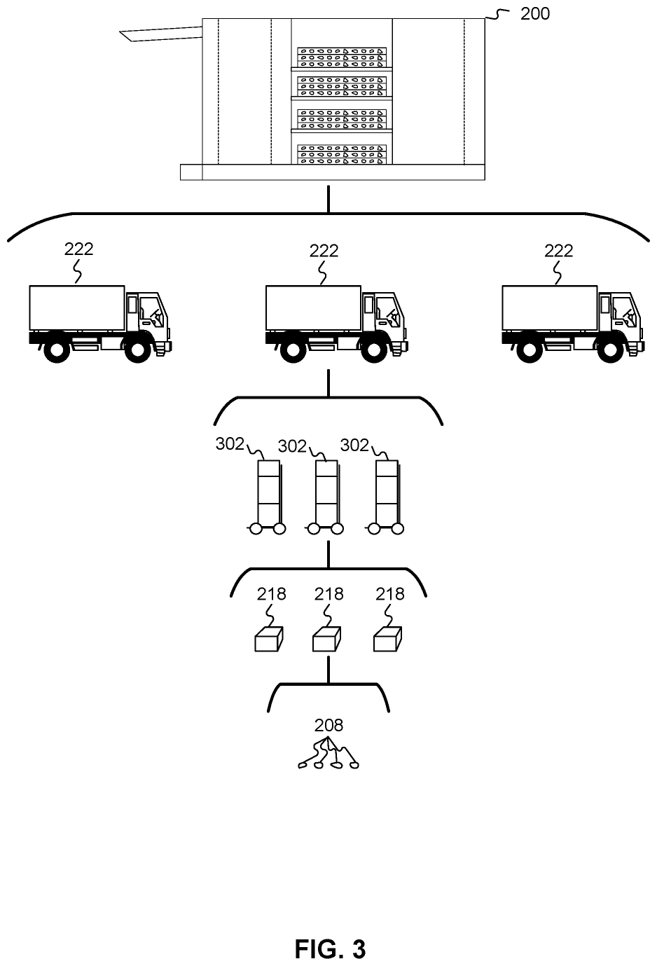

FIG. 3 is a diagrammatic illustration of item tracking layers, consistent with the disclosed embodiments. Package management systems consistent with the present disclosure may provide item tracking at any of a plurality of layers of nested groupings. For example, as shown in FIG. 3, a plurality of items 208 may be in shipment, for instance, between a warehouse and a customer. These items may be combined together in one of a plurality of packages 218. The plurality of packages may be further combined into one of a plurality of pallets 302. Further, a plurality of pallets 302 may be combined into one of a plurality of trucks 222. Further still, a plurality of trucks may be present at a fulfillment center 200 or other transit area.

To illustrate, a customer may purchase a plurality of items from an e-commerce site with a fulfillment center. Employees of the e-commerce site may place the customer's purchased items into a box. The employees may create a pallet containing the customer's box and multiple other boxes having a destination similar to the customer's, for instance, the same apartment complex. The employees may also combine multiple pallets together having similar destination areas, and load the multiple pallets onto a truck. For instance, pallets containing boxes for customers in a certain city may be combined into a truck. The truck may be loaded at the fulfillment center, along with multiple other trucks which may have the same or different destinations.

Thus, an item may be correlated with a package 218, a pallet 302, a truck 222, and a fulfillment center 200. Similarly, a warehouse may be correlated with a plurality of trucks, pallets, packages, and items; a truck may be correlated with a plurality of pallets, packages, and items; a pallet may be correlated with a plurality of packages and items; and a package may be correlated with a plurality of items. The number of grouping layers discussed above is non-limiting. Thus, for example, in some embodiments, one or more additional grouping layers may be introduced, as well, such as a collection of fulfillment centers in a region.

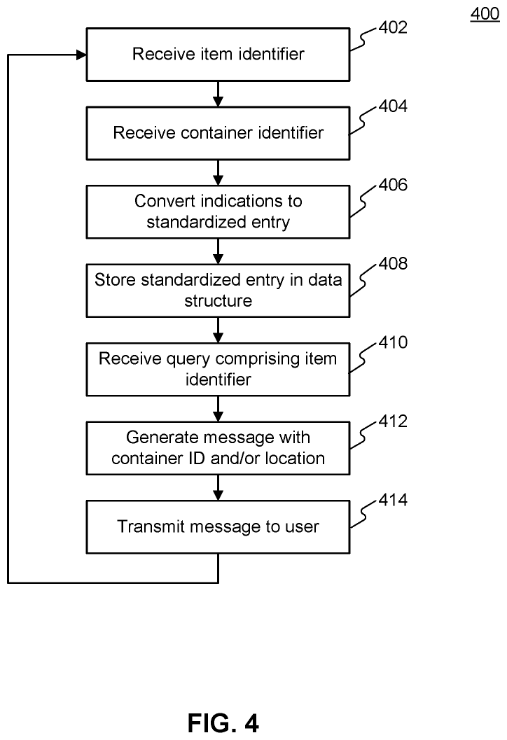

FIG. 4 is a flow chart illustrating an exemplary embodiment of a package management process 400, consistent with the disclosed embodiments. FO system 113 may run process 400 to provide a shipment tracking service to customers, for instance, as well as to aid in locating missing items and identifying loss trends.

In step 402, FO system 113 may receive an item identifier corresponding to an item in response to the item being shipped. Item shipment may begin when a customer places an order from an e-commerce site, for instance. Additionally, item shipment may begin when a person provides an item to a shipping service. In some embodiments, the item may be a return item being shipped by a purchaser back to a seller. Further, a shipper may assign an item identifier and provide the item identifier to FO system 113 at step 402. The item identifier may also be provided by a customer, such as in the case of a return. In some embodiments, FO system 113 may assign an item identifier, as well. The item identifier may indicate the item's type, size, weight, stock keeping unit (SKU), Universal Product Code (UPC), price, or return number, for instance. The item identifier may also be a free-text description of the item.

In step 404, FO system 113 may receive a container identifier corresponding to a container comprising the item. A container may be a package 218 as illustrated in FIG. 3, and may include a box or a bag. The container may also be a pallet 302 as illustrated in FIG. 3. Containers may also include shipping containers, such as 20′×40′ Container Express (CONEX) boxes, or other size shipping containers, which may be useful for shipment of large items. In some embodiments, a container may be a collection of smaller boxes secured by external straps or wrapping, as well.

Further, the container identifier may be a code assigned to the container. The code may include container specifications, such as container type, size, stacking restrictions, measured weight, or maximum weight. The code may also indicate storage requirements, such as refrigeration, climate control, or dry storage. Further still, the code may be a unique serial number assigned to the container, for instance, by a manufacturer. The container identifier may be determined by reading a barcode on the container. For instance, a technician may scan the barcode using mobile devices 107A-107C when placing the item inside the container. The identifier may also be determined by scanning a QR code. In some embodiments, the container identifier may be determined by reading an RFID tag disposed on or in a container. For example, a container's RFID tag may be scanned when the container enters a loading area of a warehouse.

In step 406, FO system 113 may convert the item identifier and container identifier into a standardized entry. For example, a shipper may use multiple container types from different manufacturers, each having different serial number patterns. FO system 113 may convert the container or item size and weight from metric to standard units. Further, FO system 113 may use regular expressions, for example, to extract sections of data of the item identifier and the container identifier, and populate fields of a format using the extracted sections. FO system 113 may also perform text manipulation (i.e., character substitutions, removals, and additions). Further, FO system 113 may execute code to populate a template based on information provided by the item identifier or container identifier. FO system 113 may also execute code to perform an automated SQL query and obtain information required to populate the template. For instance, FO system 113 may query a database to determine a manufacturer of a container based on a received container serial number, or may retrieve an origin or destination based on the item identifier.

In step 408, FO system 113 may store the standardized entry in a data structure, the data structure correlating the item identifier with the container identifier. The data structure may be, for instance, a JSON file or other dictionary having keys and corresponding values. The data structure may also be a SQL table. FO system 113 may store the data structure in memory, or the data structure may be stored in a database that FO system 113 accesses. To illustrate further, in some embodiments, the data structure may be a JSON file. The JSON file may have a key for each container tracked by FO system 113. Each container key may correspond to a list of item identifiers.

The JSON file may be hierarchical to match the nested grouping layers as presented in FIG. 3. For instance, as shown in FIG. 3, pallets having packages may be loaded onto trucks. Thus, the data structure may further comprise an identifier of a vehicle, the vehicle identifier being stored in correlation with at least one container identifier. In various embodiments, the vehicle may be any mode of transportation, such as a truck, van, airplane, boat, or train. Additional hierarchical data structure layers are also envisioned, including a storage area identifier, the storage area identifier being in correlation with at least one vehicle. The storage area may correspond to the type of vehicle, and may include, for instance, an airport, train depot, fulfillment centers, parking lot, or port.

For instance, the JSON file may use fulfillment center identifiers as keys. Each fulfillment center key may have a corresponding value that is another JSON file have vehicle identifiers as keys. Each vehicle may also have a corresponding value that is a JSON file having pallet identifiers as keys. Each pallet identifier may have a corresponding file that is a JSON file having package identifiers as keys, and each package identifier may have a value that is a list of the item identifiers of items contained in the package. To illustrate further, the data structure may be in a format of {Fulfillment Center:{Vehicle:{Pallet:{Package: Items}}}}. Thus, an item may be identified in the data structure by specifying the fulfillment center, vehicle, pallet, and/or package of the item. FO system 113 may also index the data structure by item identifier, so that specifying an item identifier may return the corresponding fulfillment center, vehicle, pallet, and package. In some embodiments, the data structure may be partitioned and stored in subsets to enable quicker searching of large data sets.

In step 410, FO system 113 may receive a query comprising the item identifier. The query may be submitted by a shipping customer requesting a tracking status of an item via a website, for instance. Alternatively, a shipping manager may submit a query to an internal shipment tracking system. In some embodiments, FO system 113 may receive or generate a plurality of queries, which may enable statistical analysis of item movements. At step 412, FO system 113 may access the data structure and identify at least one container identifier corresponding to the item identifier of the query, and generate a message comprising the container identifier. Further, FO system 113 may retrieve a location associated with the container identifier, and generate a message comprising the location. For example, in some embodiments, the data structure may have entries for trucks, containers, and items. Further, the data structure may store a location in correlation with the truck. FO system 113 may receive a query for an item identifier, find the item identifier in the data structure, and access higher-level groupings of the item identifier until FO system 113 locates a location record, for instance, for the vehicle carrying the identifier. In some embodiments, FO system 113 may receive a query for an identifier of any level of the nested grouping layers represented by the data structure, such as a container identifier, warehouse identifier, or vehicle identifier. Further, at step 414, FO system 113 may transmit the message to a user responsible for the query, such as via a website, app, text message, and the like. FO system 113 may also provide analysis of the data structure in response to a query, such as counting subordinate entries (i.e., the number of item identifiers associated with a provided vehicle identifier). FO system 113 may then return to step 402 to receive additional item identifiers, or, in some embodiments, return to step 410 to receive additional queries. Further, FO system 113 may simultaneously receive item identifiers while also receiving queries.

In addition, keys for each object of the nested grouping layers of the data structure may be obtained by scanning a bar code, QR code, or RFID tag, as described previously. In some embodiments, the data structure may also store locations for each object, as provided by a GPS tracking device disposed on each entity. For example, each container on a truck may have a GPS tracking device. The GPS tracking device may report the container's location when the container is scanned, or may send automated reports to FO system 113. FO system 113 may also receive the container location reports and access the data structure to determine other containers corresponding to the same vehicle. If the container has a location report that differs from any of the other containers, FO system 113 may flag the container as misplaced and provide a message to a shipment supervisor.

The data structure described above may enable quicker updating of item statuses. For example, FO system 113 may receive a status, such as a location and timestamp, for any of the grouping layers of the data structure. For instance, a truck may arrive at a warehouse location. When the truck arrives, a worker may scan a QR code on the truck to determine the truck identifier, and send the truck identifier to FO system 113. FO system 113, in turn, may access the data structure to locate the entry corresponding to the scanned truck identifier, and update a field with the truck location in the data structure. FO system 113 may also update a field for each level of the data structure, such that each pallet, package, and item on the truck is updated with the latest truck location. In this way, FO system 113 may enable high fidelity tracking of every item on a vehicle, without requiring a worker to record independently each item on the vehicle.

Further, the data structure described above may aid in quickly loading and unloading containers from vehicles without loss of item tracking fidelity. For example, a warehouse operator using a mobile device such as mobile devices 119A-119C may scan a container, such as a pallet 302, and send a loading indication that the container is loaded onto a vehicle, such as a truck 222. The operator may also scan the vehicle and additional containers at the same location or at different locations, and a mobile device of the operator may send additional loading indications corresponding to additional containers on the vehicle. FO system 113 may then correlate the initial container, as well as additional containers, with a vehicle identifier of the vehicle in the data structure.

FO system 113 may then receive an unloading indication that the container is being removed from a vehicle, for instance, from the warehouse operator. For example, the warehouse operator may work at a shipping hub, and may need to transfer a container from one truck arriving at the hub to another truck departing from the hub. FO system 113 may decorrelate the container from the vehicle in the data structure in response to the unloading indication. FO system 113 may then correlate the container to a holding entry of the data structure indicating that the container is at the warehouse but not yet loaded onto a truck. The new correlation may be applied to each item corresponding to the container as well. In other words, FO system 113 may apply a status change of a higher level in the hierarchy recorded in the data structure to each subordinate level in the data structure. Thus, packages in the unloaded container, as well as items in the packages, may have the same location and status in the data structure as the container. Further, FO system 113 may receive a message that the vehicle should be emptied, such as from the warehouse operator or a warehouse manager, and decorrelate at least one additional container from the vehicle in response to the message.

Further still, the operator may transfer containers from a first vehicle to a second vehicle. For instance, the operator may transfer items from a small delivery truck (i.e., a local delivery truck that fits in city streets and alleys) to a large delivery truck (i.e., a regional delivery truck that carries items from multiple local delivery trucks across highways) or other conveyance. A large regional delivery truck may transfer items from a first transit hub to a second transit hub, such that the first transit hub receives packages from a plurality of nearby origins, and the second transit hub delivers packages to destinations close to the second transit hub. For instance, the first transit hub may collect items from origins within 30 miles of the first transit hub, such as return shipments from customers, and the second transit hub may delivery items to destinations within 30 miles of the second transit hub, and the first and second transit hubs may be 300 miles apart. Therefore, to enable quicker transfer between vehicles, such as at a transit hub, while also providing a status tracking update for each item that being transferred, FO system 113 may correlate the container and the at least one additional container to a second vehicle in the data structure in response to a message that the container and the additional containers are transferred to the second vehicle.

For example, after an operator scans vehicle identifier, the operator's mobile device may ask the operator if all of the containers on the vehicle will be unloaded. If the operator indicates Yes, the mobile device may also ask the operator if the containers will be loaded onto a second vehicle. If the operator indicates Yes again, the mobile device may send a message to FO system 113, and, in response, FO system 113 may decorrelate all containers from the old vehicle and re-correlate them with the new vehicle. Further, the mobile device may request that the operator indicate a destination hub identifier, and FO system 113 may receive the destination from the mobile device and store it in the data structure in association with the new vehicle.

Further, in addition to unloading operations, FO system 113 may enable quick tracking of loading operations as well. For instance, FO system 113 may receive a loading indication that the container is being loaded onto a new vehicle, as well as the new vehicle identifier, and FO system 113 may correlate the container and its subordinate entries of the data structure with the new vehicle in the data structure.

FO system 113 may also ensure full utilization of conveyances. For instance, FO system 113 may receive a completion message indicating that a vehicle is loaded, and retrieve a vehicle container capacity. The vehicle container capacity may be stored in a database, for instance, and FO system 113 may construct a query to access the database and determine the number of containers that can fit on the vehicle. In some embodiments, FO system 113 may retrieve a vehicle volume and determine the number of containers based on container sizes, such as when containers of varying sizes are loaded onto the vehicle. Further, FO system 113 may retrieve a vehicle weight capacity and container weights.

FO system 113 may also determine a number of containers correlated to the vehicle by accessing the data structure and send, to a user device for display, a message that the vehicle is not fully loaded when the number of containers is less than the vehicle container capacity. Similarly, FO system 113 may send the message that the vehicle is not fully loaded when the weight of the containers is less than the vehicle weight capacity, or the total volume of the containers is less than a volume capacity of the vehicle. In this way, FO system 113 may take advantage of the characteristics of the data structure to quickly determine if vehicle use is being optimized, thereby decreasing inefficiencies during shipment operations.

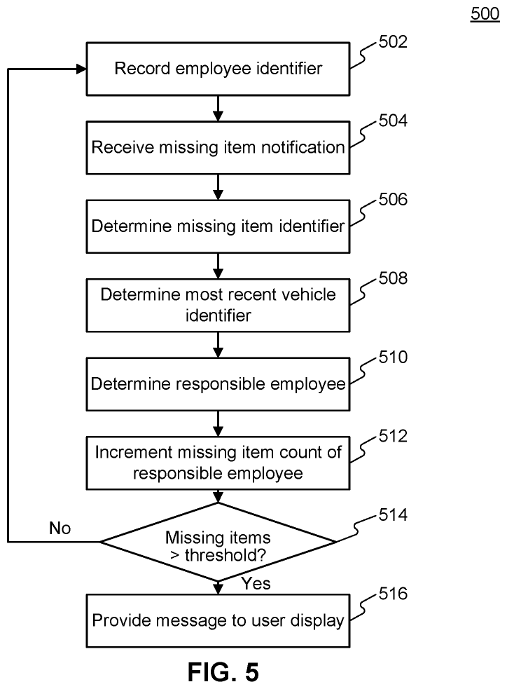

The high-speed, high-fidelity tracking update methods of the present disclosure may enable shipping organizations also to detect loss patterns quickly. FIG. 5 is a flow chart illustrating an exemplary embodiment of an employee fault detection process 500, consistent with the disclosed embodiments. Employee fault detection process 500 may also be modified to detect container, warehouse, or vehicle faults.

At step 502, FO system 113 may record an employee identifier corresponding to an employee that indicated the container was present on the vehicle. The employee identifier may be provided by a mobile device used by an employee when scanning an indicator code on the container while loading the container onto a vehicle. The employee identifier may be stored in the data structure in association with the container, thus providing a record of which employee was most recently responsible for the container.

At step 504, FO system 113 may receive a missing item notification. The missing item notification may be triggered by a customer who has not yet received an expected shipment, or a subsequent employee who, upon unloading a vehicle, discovers that the container is not present on the vehicle. Further, FO system 113 may run automated checks of the data structure to locate containers that did not have a recorded movement for a set period, and identify such containers and corresponding items as missing. For instance, if a container is not scanned for more than a day, this may indicate that the container has not been in transit, and FO system 113 may generate a missing item notification for the items associated with the container.

At step 506, FO system 113 may determine, by accessing the data structure, a missing item identifier based on the missing item notification. At step 508, FO system 113 may determine, by accessing the data structure, a most recent vehicle identifier corresponding to the missing item identifier. The most recent vehicle identifier may correspond to the last vehicle stated to be carrying the container having the missing item. Additionally, at step 510, FO system 113 may determine, by accessing the data structure, a responsible employee corresponding to the most recent vehicle identifier. In other word, the responsible employee may be the employee who indicated that the container was on the vehicle, despite the container not being on the vehicle.

At step 512, FO system 113 may increment a missing item count associated with the responsible employee. The missing item count may be stored in association with the employee identifier in a separate data structure, for instance.

In some situations, a missing item that was last loaded by an employee may be missing due to someone else's actions. For example, the employee may properly load and secure a container on a truck. However, a thief may steal the container, or an item from the container, while the truck is in transit. Thus, the missing item may not be the fault of the employee. However, if many items associated with the employee become missing, the trend may indicate that the employee is responsible, and a shipper may investigate the employee.

Thus, at step 514, FO system 113 may compare the missing item count to a threshold. If the missing item count is less than the threshold step 514 is NO, and FO system 113 may return to step 502. Alternatively, if the missing item count is greater than the threshold, step 514 is YES, and FO system 113 may proceed to step 516 to provide, to a user device for display, a message containing the responsible employee's identifying information, such as employee number or name. The message may be provided on a supervisor's user device so that the supervisor may investigate the employee's missing item trend further.

As an exemplary embodiment of the present disclosure, a computer-implemented method for package management may include a plurality of steps. The steps may include receiving an item identifier corresponding to an item in response to the item being shipped; receiving a container identifier corresponding to a container comprising the item; converting the item identifier and container identifier into a standardized entry; storing the standardized entry in a data structure, the data structure correlating the item identifier with the container identifier; receiving a vehicle identifier corresponding to a vehicle transporting the container in response to the container being loaded onto the vehicle; updating the standardized entry in the data structure to correlate an identifier of the vehicle with the container; receiving an indication of a location of the vehicle; updating the standardized entry in the data structure to include the location; generating a message comprising at least one of the vehicle identifier, the container identifier, or the location in response to a query comprising the item identifier; and transmitting the message to a user responsible for the query.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. For example, in some embodiments, steps may be substituted, replaced, added, or reordered in processes without deviating from the present disclosure. Further, in some embodiments, some steps may occur simultaneously. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for package management, comprising:
at least one processor; and
at least one non transitory storage medium storing instructions that, when executed by the at least one processor, cause the at least one processor to perform steps comprising:
receiving an item identifier corresponding to an item in response to the item being shipped;
receiving a container identifier corresponding to a container comprising the item;
converting the item identifier, the container identifier, and information obtained by querying a database using the container identifier into a standardized entry, wherein the standardized entry is converted to match a format to previously generated standardized entries;
storing the standardized entry in a data structure, the data structure correlating the item identifier with the container identifier;
generating a message comprising at least one of the container identifier or a location in response to a query comprising the item identifier and analyzed data of the data structure; and
transmitting the message to a user responsible for the query.

2. The system of claim 1, wherein the item is a return item shipped by a purchaser.

3. The system of claim 1, wherein the container identifier is determined by reading a barcode.

4. The system of claim 1, wherein the container identifier is determined by reading an RFID tag disposed on the container.

5. The system of claim 1, wherein the data structure further comprises an identifier of a vehicle, the vehicle identifier being stored in correlation with at least one container identifier.

6. The system of claim 1, wherein the steps further comprise:
receiving a first loading indication that the container is loaded onto a vehicle;
receiving a second loading indication that at least one additional container is loaded onto the vehicle;
correlating the container and the at least one additional container with a vehicle identifier corresponding to the vehicle in the data structure;
receiving an unloading indication that the container is being removed from the vehicle;
decorrelating the container from the vehicle in the data structure;
decorrelating the at least one additional containers from the vehicle in the data structure in response to a message that the vehicle should be emptied; and
correlating the container and the at least one additional container to a new vehicle in the data structure in response to a message that the container and the additional containers are transferred to the new vehicle.

7. The system of claim 5, wherein the steps further comprise:
receiving a completion message indicating that a vehicle is loaded;
retrieving a vehicle container capacity;
determining a number of containers correlated to the vehicle by accessing the data structure;
sending, to a user device for display, a message that the vehicle is not fully loaded when the number of containers is less than the vehicle container capacity.

8. The system of claim 5, wherein the steps further comprise:
recording an employee identifier corresponding to an employee that indicated the container was present on the vehicle;
receiving a missing item notification;
determining, by accessing the data structure, a missing item identifier based on the missing item notification;
determining, by accessing the data structure, a most recent vehicle identifier corresponding to the missing item identifier;
determining, by accessing the data structure, a responsible employee corresponding to the most recent vehicle identifier;
incrementing a missing item count associated with the responsible employee; and
providing, to a user device for display, a message when the missing item count of the responsible employee exceeds a threshold.

9. The system of claim 1, wherein the data structure further comprises a storage area identifier, the storage area identifier being in correlation with at least one vehicle.

10. The system of claim 1, wherein the location is provided by a GPS tracking device disposed on the container.

11. A computer-implemented method for package management, comprising:
receiving an item identifier corresponding to an item in response to the item being shipped;
receiving a container identifier corresponding to a container comprising the item;
converting the item identifier, the container identifier, and information obtained by querying a database using the container identifier into a standardized entry, wherein the standardized entry is converted to match a format to previously generated standardized entries;
storing the standardized entry in a data structure, the data structure correlating the item identifier with the container identifier;
generating a message comprising at least one of the container identifier or a location in response to a query comprising the item identifier and analyzed data of the data structure; and
transmitting the message to a user responsible for the query.

12. The computer-implemented method of claim 11, wherein the item is a return item shipped by a purchaser.

13. The computer-implemented method of claim 11, wherein the container identifier is determined by reading a barcode.

14. The computer-implemented method of claim 11, wherein the container identifier is determined by reading an RFID tag disposed on the container.

15. The computer-implemented method of claim 11, wherein the data structure further comprises an identifier of a vehicle, the vehicle identifier being stored in correlation with at least one container identifier.

16. The computer-implemented method of claim 11, wherein the steps further comprise:
receiving a first loading indication that the container is loaded onto a vehicle;
receiving a second loading indication that at least one additional container is loaded onto the vehicle;
correlating the container and the at least one additional container with a vehicle identifier corresponding to the vehicle in the data structure;
receiving an unloading indication that the container is being removed from the vehicle;
decorrelating the container from the vehicle in the data structure;
decorrelating the at least one additional containers from the vehicle in the data structure in response to a message that the vehicle should be emptied; and
correlating the container and the at least one additional container to a new vehicle in the data structure in response to a message that the container and the additional containers are transferred to the new vehicle.

17. The computer-implemented method of claim 15, wherein the steps further comprise:
receiving a completion message indicating that a vehicle is loaded;
retrieving a vehicle container capacity;
determining a number of containers correlated to the vehicle by accessing the data structure;
sending, to a user device for display, a message that the vehicle is not fully loaded when the number of containers is less than the vehicle container capacity.

18. The computer-implemented method of claim 15, wherein the steps further comprise:
recording an employee identifier corresponding to an employee that indicated the container was present on the vehicle;
receiving a missing item notification;
determining, by accessing the data structure, a missing item identifier based on the missing item notification;
determining, by accessing the data structure, a most recent vehicle identifier corresponding to the missing item identifier;
determining, by accessing the data structure, a responsible employee corresponding to the most recent vehicle identifier;
incrementing a missing item count associated with the responsible employee; and
providing, to a user device for display, a message when the missing item count of the responsible employee exceeds a threshold.

19. The computer-implemented method of claim 11, wherein the data structure further comprises a storage area identifier, the storage area identifier being in correlation with at least one vehicle.

20. A computer-implemented method for package management, comprising:
receiving an item identifier corresponding to an item in response to the item being shipped;
receiving a container identifier corresponding to a container comprising the item;
converting the item identifier and container identifier into a standardized entry;
storing the standardized entry in a data structure, the data structure correlating the item identifier with the container identifier;
receiving a vehicle identifier corresponding to a vehicle transporting the container in response to the container being loaded onto the vehicle;
updating the standardized entry in the data structure to correlate an identifier of the vehicle with the container;
receiving an indication of a location of the vehicle;
updating the standardized entry in the data structure to include the location;
generating a message comprising at least one of the vehicle identifier, the container identifier, or the location in response to a query comprising the item identifier; and
transmitting the message to a user responsible for the query.
